(19) United States
(12) Patent Application Publication
(10) Pub. No.: US 2009/0198006 A1
(43) Pub. Date: Aug. 6, 2009

(54) Methods And Compositions For Depositing Silver Onto A Metal Surface

(76) Inventor: Roger F. Bernards, South Haven, MN (US)

Correspondence Address: MCANDREWS HELD & MALLOY, LTD, 500 WEST MADISON STREET, SUITE 3400, CHICAGO, IL, 60661, US

(21) Appl. No.: 12/024,401

(22) Filed: Feb. 1, 2008

(51) Int. Cl. C08K 3/22

(52) U.S. Cl. 524/413

(57) ABSTRACT

The current method and composition relate to depositing silver onto a metal surface using an acid selected from the group consisting of salicylic acid and salicylic acid derivatives; a source of silver ions; and an additive selected from the group consisting of polyethylene glycol, a block copolymer of polyethylene glycol and

polypropylene glycol, polypropylene glycol, block copolymers based on ethylenediamine as a core derivatives of any of the foregoing and mixtures of any of the foregoing.

### RELATED APPLICATION(S)

[Not Applicable]

### FIELD OF THE INVENTION

The present technology generally relates to methods and compositions for depositing silver onto a metal surface. Specifically, the present technology includes methods and compositions for improving solderability of a printed wiring board.

### BACKGROUND OF THE INVENTION

Printed wiring boards are formed from a layer of conductive material (commonly, copper or copper plated with solder or gold) carried on a substrate of insulating material (commonly glass-fiber-reinforced epoxy resin). A printed wiring board having two conductive surfaces positioned on opposite sides of a single insulating layer is known as a “double-sided circuit board.” To accommodate even more circuits on a single board, several copper layers are sandwiched between boards or other layers of insulating material to produce a multi-layer wiring board.

Printed wiring boards typically also use through hole technology. Through holes are used to mount electronic components. Through hole technology uses pins on the electronic components that are inserted into holes drilled in a printed wiring board and soldered to pads on the opposite side.

Soldering is a process that is used to bond similar or dissimilar materials by melting a filler metal or alloy that is placed between the components being joined. In the manufacture of printed circuit boards, soldering is used to make electrical connections to and between printed circuits. Specifically, soldering is carried out by coating the through hole walls and other conductive surfaces of a printed wiring board with hot, molten solder to make electrical connections by wetting and filling the spaces between the conductive through hole surfaces and the leads of electrical components which have been inserted through the through holes. If the solder adheres inconsistently to the conductive surfaces, or forms too weak a bond with the conductive surfaces, the circuit board can fail or malfunction.

Soldering inconsistencies are often the result of difficulties in keeping the conductive surfaces of the printed circuit board clean and free of tarnishing (oxidation) prior to and during the soldering process. A number of treatments have been developed to preserve conductive surfaces (in particular, copper surfaces) in order to improve solderability. For example, Hot Air Solder Leveling (HASL) techniques apply a thin layer of solder to preserve the conductive surfaces and improve solderability in subsequent soldering steps. Other techniques which have been used to prevent surface oxidation and improve solderability include Electroless Nickel/Immersion Gold (ENIG), Organic Solder Preservative (OSP), immersion tin and immersion silver techniques.

Immersion silver deposits provide excellent solderability preservatives. One immersion silver deposit process and formulation is described in co-owned U.S. patent application Ser. No. 11/226613 (Bernards et al.), which is incorporated in its entirety by reference. Bernards et al. uses an acid, a source of silver ions and an additive selected from the group of pyrroles, triazoles, tetrazoles, derivatives of the foregoing and mixtures of the foregoing.

### SUMMARY OF THE INVENTION

It has been found that the use of some previously used silver plating solutions generate foam. Foamy plating solutions are more difficult to control and handle than a liquid solution that does not foam excessively when pumped through standard application equipment. Foam is hard to contain in formal industrial equipment.

Foamy plating solutions have been applied using a horizontal immersion bath method, where the surface is laid horizontally into a tray and plating solution is constantly pumped into the tray. The horizontal immersion bath method of silver plating creates pools of plating solution on the surface of the copper. It has now been found that completely submerging the circuit board into the pools of plating solution on the copper surface can result in a solder mask interface galvanic attack. Solder mask interface galvanic attack is caused by the reaction of entrapped plating solution. Where there are limited silver ions supplied, such as in an area of entrapped plating solution, the plating solution will begin to etch the copper surface. Solder mask interface galvanic attack is undesirable because it etches the copper surface.

It has also been found that foamy plating solutions are not well suited for application using a vertical spray application method. In a vertical spray application method, the surface is situated in a vertical or slanted orientation and the plating solution is applied onto the surface by spray nozzles. Runoff solution from the application is caught in a catch-chamber beneath the surface. A solution that foams tends to spill out of the catch-chamber and onto the floor. This spilling wastes plating solution and contaminates the work area with acid, silver and copper metals from the plating solution. Spray applications do not submerge the entire work piece into a liquid tank or pool of solution. This complete submersion is now believed to make the galvanic attack much worse by creating a galvanic corrosion pathway through the solution pool.

The current silver deposit solution comprises an acid selected from the group consisting of salicylic acid and salicylic acid derivatives; a source of silver ions; and an additive selected from the group consisting of polyethylene glycol, a block copolymer of polyethylene glycol and polypropylene glycol, polypropylene glycol, block copolymers based on ethylenediamine as a core derivatives of any of the foregoing and mixtures of any of the foregoing.

In one embodiment, the silver deposit is non-foaming or low foaming.

In other embodiments the silver deposit solution can include optional ingredients. The silver deposit solution can further comprise a mineral acid, such as nitric acid. The silver deposit solution of can further comprise a chelator, such as N-(2-hydroxyethyl)ethylenediaminetriacetic acid or its salts. The silver deposit solution can further comprise a surfactant, such as a phosphate ester surfactant.

The current process of depositing silver onto a metal surface, comprises providing a metal surface; and applying a silver deposit solution to the metal surface, the silver deposit solution comprising; an acid selected from the group consisting of salicylic acid and salicylic acid derivatives; a source of silver ions; and an additive selected from the group consisting of polyethylene glycol, a block copolymer of polyethylene glycol and polypropylene glycol, polypropylene glycol, block copolymers based on ethylenediamine as a core, derivatives of any of the foregoing and mixtures of any of the foregoing.

In one embodiment, the silver deposit solution is contacted onto a copper surface, such as a printed wiring board. In another embodiment the metal surface is positioned vertically and the silver deposit solution is sprayed on the metal surface. In another embodiment, the solution used in the process is non-foaming or low foaming.

Another embodiment, of the current silver deposit solution comprises an acid selected from the group consisting of salicylic acid and salicylic acid derivatives; a source of silver ions; and a phosphate ester surfactant.

In one embodiment, the silver deposit is non-foaming or low foaming.

In other embodiments the silver deposit solution can include optional ingredients. The silver deposit solution can further comprise a mineral acid, such as nitric acid. The silver deposit solution of can farther comprise a chelator, such as N-(2-hydroxyethyl)ethylenediaminetriacetic acid or its salts.

Another embodiment of the current process of depositing silver onto a metal surface, comprises providing a metal surface; and applying a silver deposit solution to the metal surface, the silver deposit solution comprising; an acid selected from the group consisting of salicylic acid and salicylic acid derivatives; a source of silver ions; and a phosphate ester surfactant.

In one embodiment, the silver deposit solution is contacted onto a copper surface, such as a printed wiring board. In another embodiment the metal surface is positioned vertically and the silver deposit solution is sprayed on the metal surface. In another embodiment, the solution used in the process is non-foaming or low foaming.

Another embodiment of the current aqueous silver deposit solution comprises an acid; a source of silver ions; and an additional component wherein said aqueous silver deposit solution forms less than 20 mL of foam when added to water in a graduated cylinder and agitated.

### DETAILED DESCRIPTION OF THE PREFERRED EMBODIMENT(S)

The present methods and compositions generally relate to depositing silver onto a metal surface. Specifically, the present methods and compositions relate to improving solderability of a printed wiring board. The embodiments disclosed herein are intended to be illustrative and it will be understood that the invention is not limited to these embodiments since modification can be made by those of skill in the art without departing from the scope of the present disclosure.

One embodiment of current silver deposit solution comprises an acid, a source of silver ions and an additive. The current silver deposit solution can be low foaming or non-foaming. A non-foaming solution is a solution that will not form foam or will form only an insignificant amount (less than 1 mL) of foam when added to water in a graduated cylinder and agitated. A low foaming solution is a solution that will form less than about 20 mL, alternatively less than about 10 mL, or alternatively less than about 5 mL of foam when added to water in a graduated cylinder and agitated.

One embodiment of the current silver deposit solution comprises a salicylic acid or salicylic acid derivative, a source of silver ions, and a polymeric additive selected from among polyethylene glycol, a block copolymer of polyethylene glycol and polypropylene glycol, polypropylene glycol, block copolymers based on ethylenediamine as a core, derivatives of any of the foregoing and mixtures of any of the foregoing. The current silver deposit solution can be used to improve the solderability of a printed wiring board.

Any suitable salicylic acid or salicylic acid derivative known to those in the art may be used in the present solution. The salicylic acid or salicylic acid derivative may have the formula:

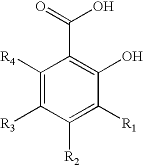

wherein examples of R1, R2, R3, R4 include hydrogen molecules, nitro groups, sulfate groups, aryl groups, alkyl groups, phenyl groups, hydroxyl groups, nitrate groups, and halogen molecules. R1, R2, R3, R4 can be the same or different from each other. In one embodiment the salicylic acid derivative is 3,5-dinitro salicylic acid, R1 and R3 are nitro groups. In yet another embodiment the salicylic acid derivative is 6-hydroxy salicylic acid, R4 is a hydroxyl group.

The salicylic acid or salicylic acid derivative may be present in any amount suitable to effectuate the deposit of the silver onto the substrate. By way of example, the salicylic acid or salicylic acid derivative may be present in the solution in the range between about 0.01 weight percent and about 20 weight percent, alternatively between about 0.5 weight percent and about 10 weight percent, alternatively between about 1 weight percent and about 5 weight percent. The weight percentages above assume the use of an undiluted acid as opposed to an acid solution. If an acid solution is used, the weight percentages should be adjusted accordingly.

As an alternative to the above, the acid may be added to the solution in an amount sufficient to lower the pH of the solution to below 7. Alternatively, the pH of the solution may be below 3. In yet another alternative, the pH of the solution may be below 2.

Any suitable source of silver ions known to those in the art may be used in the present solution. The source of silver ions can be a silver metal salt. Possible silver metal salts include silver nitrate, and silver sulfate. The concentration of the silver ions in the solution will vary depending on a number of factors such as the method used to apply the solution, the speed at which the user wishes to deposit the silver, etc. As an example the silver ions may be present in the solution in the range between about 0.25 and about 5.0 grams silver ions per liter, alternatively in the range between about 1 and about 2 grams silver ions per liter.

As stated above, the present solution contains a polymeric additive selected from the group consisting of polyethylene glycol, a block copolymer of polyethylene glycol and polypropylene glycol, polypropylene glycol, block copolymers based on ethylenediamine as a core, derivatives of any of the foregoing and mixtures of any of the foregoing. Any suitable polyethylene glycol or polyethylene glycol derivative can be used in the present solution. Any suitable block copolymer of polyethylene glycol and polypropylene glycol or derivative thereof can be used in the present solution. Any suitable polypropylene glycol or polypropylene glycol derivative can be used in the present solution. Any suitable block copolymer based on ethylenediamine as a core can be used in the present solution.

In one embodiment of the current silver deposit solution the additive is polyethylene glycol or a polyethylene glycol derivative having the following structural formula:

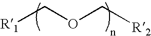

wherein n indicates the number of repeating ethylene monomer units and examples of R′1, R′2 include alcohols, fatty acids, alkanes, and unsaturated alkanes. Possible ranges for n include 3 to 250, or alternatively 4 to 20. R′1 and R′2 can be the same or different from each other.

In one embodiment of the current silver deposit solution the additive is polypropylene glycol or a polypropylene glycol derivative having the following structural formula:

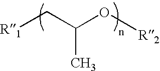

wherein n indicates the number of repeating polymer units and examples of R″1, R″2 include alcohols, fatty acids, alkanes, and unsaturated alkanes. Possible ranges for n include 3 to 250, or alternatively 4 to 20. R″1 and R″2 can be the same or different from each other.

In one embodiment of the current silver deposit solution the additive is a block copolymer of polyethylene glycol and polypropylene glycol or derivative thereof having the following structural formula:

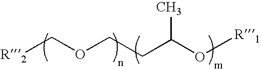

wherein n and m indicate the number of repeating polymer units and examples of R′″1, R′″2 include alcohols, fatty acids, alkanes, and unsaturated alkanes. Possible ranges for n include 3 to 250, or alternatively 4 to 20. Possible ranges for m include 3 to 250, or alternatively 4 to 20. R′″1 and R′″2 can be the same or different from each other.

In one embodiment of the current silver deposit solution the additive is a block copolymer based on ethylenediamine as a core having the following structural formula:

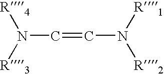

wherein examples of R″″1, R″″2, R″″3, R″″4 include
blocks of polyethylene glycol and polypropylene glycol with either a polyethylene glycol chain or the polypropylene glycol chain on the outside. R″″1, R″″2, R″″3, and R″″4 can be the same or different from each other.

In one embodiment 425-molecular weight polypropylene glycol can be used in the present solution. In yet another embodiment Pluronic L44 (polyethylene-polypropylene glycol copolymer made up of 40% polyethylene and having a molecular weight of 1000-1200) can be used in the present solution.

The additive described above may be present in any amount suitable to effectuate the deposit of the silver onto the substrate. As an example, the additive may be present in the solution in the range of between about 0.001 and about 100 grams per liter, alternatively in the range of about 0.1 and about 10 grams per liter, alternatively in the range of about 0.5 and about 2.0 grams per liter. Alternatively, the glycol additive may be added to the solution in any quantity that creates a non-foaming or low foaming solution.

When a polymeric additive is used, the current silver deposit solution can be low foaming or non-foaming. A non-foaming solution is a solution that will not form foam or will form only an insignificant amount (less than 1 mL) of foam when added to water in a graduated cylinder and agitated. A low foaming solution is a solution that will form less than about 20 mL, alternatively less than about 10 mL, or alternatively less than about 5mL of foam when added to water in a graduated cylinder and agitated.

In other embodiments optional components that will not compromise the silver depositing process can also be added. Non-limiting examples of such optional components include surfactants, acids, chelators, buffers, complexing agents, silver stabilizers, oxidizers, dyes, wetting agents or other chemicals.

The present solution may optionally contain a surfactant. Any suitable surfactant known to those in the art may be used in the present solution. Non-limiting examples of suitable surfactants include a phosphate ester surfactant. Any suitable phosphate ester surfactant can be used such as phosphate esters of nonyl phenols, linear (branched or un-branched) alcohol ethoxylates, fatty acids, saturated and unsaturated hydrocarbons that are or are not ethoxylated. One example is a phosphate ester of tridecyl alcohol ethoxylate such as Rhodafac RS 610 from Rhodia. The surfactant may be present in the solution in the range between about 0.02 grams per liter and about 100 grams per liter, alternatively between about 0.1 grams per liter and about 30 grams per liter, alternatively between about 0.3 grams per liter and about 7 grams per liter.

The present solution may optionally contain a mineral acid or multiple mineral acids in conjunction with the salicylic acid or salicylic acid derivative discussed above. Any suitable organic or inorganic acid known to those in the art may be used in the present solution. Non-limiting examples of suitable acids include nitric, sulfuric, glycolic, hydrochloric and acetic. The acid may be present in the solution in the range between about 0.01 weight percent and about 20 weight percent, alternatively between about 0.5 weight percent and about 10 weight percent, alternatively between about 1 weight percent and about 5 weight percent. The weight percentages above assume the use of an undiluted acid as opposed to an acid solution. If an acid solution is used, the weight percentages should be adjusted accordingly.

The present solution may optionally contain a chelator. Any suitable chelator known to those in the art may be used in the present solution. Non-limiting examples of suitable chelators include N-(2-hydroxyethyl)ethylenediaminetriacetic acid (HEDTA) and its salts. The chelator may be present in the solution in the range between about 0.1 grams per liter and about 40.0 grams per liter, alternatively between about 1.0 grams per liter and about 30.0 grams per liter, alternatively between about 5.0 grams per liter and about 20.0 grams per liter.

The present solution may optionally contain a buffer. Any suitable buffer known to those in the art may be used in the present solution. Non-limiting examples of suitable buffers include phosphate buffers such as potassium hydrogen phosphate. The buffer may be present in the solution in the range between about 0.01 grams per liter and about 20.0 grams per liter, alternatively between about 0.1 grams per liter and about 10 grams per liter, alternatively between about 1 gram per liter and about 10 grams per liter.

The present solution may optionally contain a complexing agent. Any suitable complexing agent known to those in the art may be used in the present solution. Non-limiting examples of suitable complexing agents include triazoles, benzotriazoles, tetrazoles, and other N-heterocycles. The complexing agent may be present in the solution in the range between about 0.001 grams per liter and about 20 grams per liter, alternatively between about 0.1 grams per liter and about 5 grams per liter, alternatively between about 0.3 grams per liter and about 2 grams per liter.

The present solution may optionally contain a silver stabilizer. Any suitable silver stabilizer known to those in the art may be used in the present solution. Non-limiting examples of suitable silver stabilizers include sulfur compounds. The silver stabilizer may be present in the solution in the range between about 0.02 grams per liter and about 100 grams per liter, alternatively between about 0.1 grams per liter and about 30 grams per liter, alternatively between about 0.3 grams per liter and about 7 grams per liter.

In one embodiment, nitric acid and a chelator are added to the silver deposit solution. The nitric acid may be present in the solution in the range between about 0.1 weight percent and about 18 weight percent, alternatively between about 0.5 weight percent and about 5 weight percent, alternatively between about 1 weight percent and about 3 weight percent. The weight percentages above assume the use of undiluted nitric acid as opposed to a nitric acid solution. If a nitric acid solution is used, the weight percentages should be adjusted accordingly. The chelator may be present in the solution in the range between about 0.1 grams per liter and about 100 grams per liter, alternatively between about 1 gram per liter and about 20 grams per liter, alternatively between about 5 grams per liter and about 15 grams per liter. In one embodiment, the chelator can be N-(2-hydroxyethyl)ethylenediaminetriacetic acid (HEDTA) or one of its salts.

The current silver deposit solution using a polymeric additive can be in the form of an aqueous solution. An embodiment of the aqueous solution is made up of from about 0.5 grams per liter to about 2 grams per liter silver nitrate, and from about 0.25 grams per liter to about 2 grams per liter salicylic acid and from about 0.25 grams per liter to about 5 grams per liter block copolymer, alternatively from about 1.0 grams per liter to about 1.5 grams per liter silver nitrate, and from about 0.5 grams per liter to about salicylic acid and from about 1 grams per liter to about 2.5 grams per liter block copolymer, alternatively about 1.5 grams per liter silver nitrate, and about 0.75 grams per liter salicylic acid and about 1 gram per liter block copolymer.

The salicylic acid can be any salicylic acid suitable for use in the current aqueous solution. The salicylic acid can be any salicylic acid discussed above in this application. As specific examples, the salicylic acid could be 3,5-dinitro salicylic acid or 6-hydroxy salicylic acid. The block copolymer can be a block copolymer suitable for use in the current aqueous solution. The block copolymer can be any block copolymer discussed above in this application. As specific examples, the block copolymer could be Pluronic L44 (polyethylene-polypropylene glycol made up of 40% polyethylene and having a molecular weight of 1000-1200), Pluronic L35 or Tetronic 90R-4.

The above embodiment of the current aqueous silver deposit solution can additionally contain from about 0.1 weight percent to about 18 weight percent nitric acid and from about 0.1 grams per liter to about 100 grams per liter chelator, alternatively from about 0.5 weight percent to about 5 weight percent nitric acid and from about 1 grams per liter to about 20 grams per liter chelator, alternatively from about 2 weight percent to about 5 weight percent nitric acid and from about 5 grams per liter to about 15 grams per liter chelator. The chelator can be a block copolymer suitable for use in the current aqueous solution. For example the chelator could be N-(2-hydroxyethyl)ethylenediaminetriacetic acid (HEDTA) or one of its salts.

The current aqueous silver deposit solution using a polymeric additive can be used to improve the solderability of a printed wiring board. The current aqueous solution can be low foaming or non-foaming.

Another embodiment of the current silver deposit solution comprises a salicylic acid or salicylic acid derivative, a source of silver ions, and a phosphate ester surfactant additive. The current silver deposit solution can be used to improve the solderability of a printed wiring board.

Any suitable salicylic acid or salicylic acid derivative known to those in the art may be used in the present solution. The salicylic acid or salicylic acid derivative may have the formula:

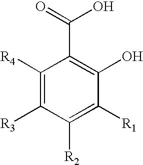

wherein examples of R1, R2, R3, R4 include hydrogen molecules, nitro groups, sulfate groups, aryl groups, alkyl groups, phenyl groups, hydroxyl groups, nitrate groups, and halogen molecules. R1, R2, R3, R4 can be the same or different from each other. In one embodiment the salicylic acid derivative is 3,5-dinitro salicylic acid, R1 and R3 are nitro groups. In yet another embodiment the salicylic acid derivative is 6-hydroxy salicylic acid, R4 is a hydroxyl group.

The salicylic acid or salicylic acid derivative may be present in any amount suitable to effectuate the deposit of the silver onto the substrate. By way of example, the salicylic acid or salicylic acid derivative may be present in the solution in the range between about 0.01 weight percent and about 20 weight percent, alternatively between about 0.5 weight percent and about 10 weight percent, alternatively between about 1 weight percent and about 5 weight percent. The weight percentages above assume the use of an undiluted acid as opposed to an acid solution. If an acid solution is used, the weight percentages should be adjusted accordingly.

As an alternative to the above, the acid may be added to the solution in an amount sufficient to lower the pH of the solution to below 7. Alternatively, the pH of the solution may be below 3. In yet another alternative, the pH of the solution may be below 2.

Any suitable source of silver ions known to those in the art may be used in the present solution. The source of silver ions can be a silver metal salt. Possible silver metal salts include silver nitrate, and silver sulfate. The concentration of the silver ions in the solution will vary depending on a number of factors such as the method used to apply the solution, the speed at which the user wishes to deposit the silver, etc. As an example the silver ions may be present in the solution in the range between about 0.25 and about 5.0 grams silver ions per liter, alternatively in the range between about 1 and about 2 grams silver ions per liter.

As stated above, the present solution contains a phosphate ester surfactant additive. Any suitable phosphate ester surfactant can be used such as phosphate esters of nonyl phenols, linear (branched or un-branched) alcohol ethoxylates, fatty acids, saturated and un-saturated hydrocarbons that are or are not ethoxylated. One example is a phosphate ester of tridecyl alcohol ethoxylate such as Rhodafac RS 610 from Rhodia. The surfactant may be present in the solution in the range between about 0.02 grams per liter and about 100 grams per liter, alternatively between about 0.1 grams per liter and about 30 grams per liter, alternatively between about 0.3 grams per liter and about 7 grams per liter.

Previously used silver deposit solutions used a phosphate ester surfactant in conjunction with other surfactants and produced a foaming silver deposit solution. For example, a silver deposit solution containing a phosphate ester surfactant with nonionic surfactants such as nonyl phenol ethoxylates or linear alkyl ethoxylates has been found to form a foaming silver deposit solution. However, when a phosphate ester surfactant is used in the absence of these other surfactants, the current silver deposit solution can be low foaming or non-foaming. A non-foaming solution is a solution that will not form foam or will form only an insignificant amount (less than 1 mL) of foam when added to water in a graduated cylinder and agitated. A low foaming solution is a solution that will form less than about 20 mL, alternatively less than about 10 mL, or alternatively less than about 5mL of foam when added to water in a graduated cylinder and agitated.

Adding a phosphate ester surfactant additive offers another advantage. After a surface has been plated with silver using the current silver deposit solution containing a phosphate ester surfactant additive the surface exhibits good dewetting properties. Dewetting properties are exhibited after rinsing. Water will form beads or droplets on a surface with good dewetting properties. Surfaces having good dewetting properties show better corrosion resistance than those that do not have good dewetting properties.

In other embodiments optional components that will not compromise the silver depositing process can also be added. Non-limiting examples of such optional components include a polymeric additive (such as those described above), additional non-foaming surfactants, acids, chelators, buffers, complexing agents, silver stabilizers, oxidizers, dyes, wetting agents or other chemicals.

The present solution may optionally contain a polymeric additive selected from the group consisting of polyethylene glycol, a block copolymer of polyethylene glycol and polypropylene glycol, polypropylene glycol, block copolymers based on ethylenediamine as a core, derivatives of any of the foregoing and mixtures of any of the foregoing. The additive may be present in the solution in the range of between about 0.001 and about 100 grams per liter, alternatively in the range of about 0.1 and about 10 grams per liter, alternatively in the range of about 0.5 and about 2.0 grams per liter.

The present solution may optionally contain an additional non-foaming surfactant. Suitable surfactants known to those in the art may be used in the present solution. However, foaming surfactants such as those listed above should be avoided. The surfactant may be present in the solution in the range between about 0.02 grams per liter and about 100 grams per liter, alternatively between about 0.1 grams per liter and about 30 grams per liter, alternatively between about 0.3 grams per liter and about 7 grams per liter.

The present solution may optionally contain a mineral acid or multiple mineral acids in conjunction with the salicylic acid or salicylic acid derivative discussed above. Any suitable organic or inorganic acid known to those in the art may be used in the present solution. Non-limiting examples of suitable acids include nitric, sulfuric, glycolic, hydrochloric and acetic. The acid may be present in the solution in the range between about 0.01 weight percent and about 20 weight percent, alternatively between about 0.5 weight percent and about 10 weight percent, alternatively between about 1 weight percent and about 5 weight percent. The weight percentages above assume the use of an undiluted acid as opposed to an acid solution. If an acid solution is used, the weight percentages should be adjusted accordingly.

The present solution may optionally contain a chelator. Any suitable chelator known to those in the art may be used in the present solution. Non-limiting examples of suitable chelators include N-(2-hydroxyethyl)ethylenediaminetriacetic acid (HEDTA) and its salts. The chelator may be present in the solution in the range between about 0.1 grams per liter and about 40.0 grams per liter, alternatively between about 1.0 grams per liter and about 30.0 grams per liter, alternatively between about 5.0 grams per liter and about 20.0 grams per liter.

The present solution may optionally contain a buffer. Any suitable buffer known to those in the art may be used in the present solution. Non-limiting examples of suitable buffers include phosphate buffers such as potassium hydrogen phosphate. The buffer may be present in the solution in the range between about 0.01 grams per liter and about 20.0 grams per liter, alternatively between about 0.1 grams per liter and about 10 grams per liter, alternatively between about 1 gram per liter and about 10 grams per liter.

The present solution may optionally contain a complexing agent. Any suitable complexing agent known to those in the art may be used in the present solution. Non-limiting examples of suitable complexing agents include triazoles, benzotriazoles, tetrazoles, and other N-heterocycles. The complexing agent may be present in the solution in the range between about 0.001 grams per liter and about 20 grams per liter, alternatively between about 0.1 grams per liter and about 5 grams per liter, alternatively between about 0.3 grams per liter and about 2 grams per liter.

The present solution may optionally contain a silver stabilizer. Any suitable silver stabilizer known to those in the art may be used in the present solution. Non-limiting examples of suitable silver stabilizers include sulfur compounds. The silver stabilizer may be present in the solution in the range between about 0.02 grams per liter and about 100 grams per liter, alternatively between about 0.1 grams per liter and about 30 grams per liter, alternatively between about 0.3 grams per liter and about 7 grams per liter.

In one embodiment, nitric acid and a chelator are added to the silver deposit solution. The nitric acid may be present in the solution in the range between about 0.1 weight percent and about 18 weight percent, alternatively between about 0.5 weight percent and about 5 weight percent, alternatively between about 1 weight percent and about 3 weight percent. The weight percentages above assume the use of undiluted nitric acid as opposed to a nitric acid solution. If a nitric acid solution is used, the weight percentages should be adjusted accordingly. The chelator may be present in the solution in the range between about 0.1 grams per liter and about 100 grams per liter, alternatively between about 1 gram per liter and about 20 grams per liter, alternatively between about 5 grams per liter and about 15 grams per liter. In one embodiment, the chelator can be N-(2-hydroxyethyl)ethylenediaminetriacetic acid (HEDTA) or one of its salts.

The current silver deposit solution using a phosphate ester surfactant additive can be in the form of an aqueous solution. An embodiment of the aqueous solution is made up of from about 0.5 grams per liter to about 2 grams per liter silver nitrate, and from about 0.25 grams per liter to about 2 grams per liter salicylic acid and from about 0.1 grams per liter and about 30 grams per liter of a phosphate ester of tridecyl alcohol ethoxylate, alternatively from about 1.0 grams per liter to about 1.5 grams per liter silver nitrate, and from about 0.5 grams per liter to about salicylic acid and from about 0.3 grams per liter and about 7 grams per liter of a phosphate ester of tridecyl alcohol ethoxylate, alternatively about 1.5 grams per liter silver nitrate, and about 0.75 grams per liter salicylic acid and about 1 to 5 gram per liter of a phosphate ester of tridecyl alcohol ethoxylate. The salicylic acid can be any salicylic acid suitable for use in the current aqueous solution. The salicylic acid can be any salicylic acid discussed above in this application. As specific examples, the salicylic acid could be 3,5-dinitro salicylic acid or 6-hydroxy salicylic acid.

The above embodiment of the current aqueous silver deposit solution can additionally contain from about 0.1 weight percent to about 18 weight percent nitric acid and from about 0.1 grams per liter to about 100 grams per liter chelator, alternatively from about 0.5 weight percent to about 5 weight percent nitric acid and from about 1 grams per liter to about 20 grams per liter chelator, alternatively from about 2 weight percent to about 5 weight percent nitric acid and from about 5 grams per liter to about 15 grams per liter chelator. The chelator can be a block copolymer suitable for use in the current aqueous solution. For example the chelator could be N-(2-hydroxyethyl)ethylenediaminetriacetic acid (HEDTA) or one of its salts.

The current aqueous silver deposit solution using a phosphate ester surfactant additive can be used to improve the solderability of a printed wiring board. The current aqueous solution can be low foaming or non-foaming.

The current method of depositing silver onto a metal surface comprises providing a metal surface and applying a silver deposit solution as described herein to the metal surface. The current method of depositing silver onto a metal surface can be carried out using the silver deposit solution having a polymeric additive or a phosphate ester surfactant additive, both as described above.

The metal surface may be comprised of any metal or alloy. In some embodiments it may be any metal or alloy to which a solder may be applied. Non-limiting examples of suitable metal surfaces include copper, lead, nickel, cobalt, iron, tin, zinc, chromium, aluminum, and alloys thereof. In one embodiment, the metal surface is comprised of copper or a copper alloy. The metal surface could be a surface on a printed wiring board. Where the metal surface is a printed wiring board, the current method can be used to improve the solderability of a printed wiring board.

The metal surface can be treated with the current silver deposit solution in a variety of ways, including (but not limited to) immersion in a bath, dipping in a bath or spraying. The current silver deposit solution is well suited for a spraying application because the current silver deposit solution is low foaming.

The treatment may take place at any temperature suitable to obtain the desired silver plating. For example, the desired result may be achieved where the temperature during treatment is in the range from about 50° F. to about 160° F. (about 10° C. to about 71° C.), alternatively from about 90° F. to about 140° F. (about 32° C. to about 60° C.), alternatively from about 110° F. to about 130° F. (about 43° C. to about 54° C.). The desired silver plating may be achieved outside these ranges, however.

The treatment may take place for any duration of time suitable to obtain the desired silver plating. For example, the desired result may be achieved where the silver deposit solution is contacted with the metal surface for about 20 second to 15 minutes, alternatively from about 30 seconds to about 5 minutes, alternatively from about 1 minute to about 2 minutes. The desired silver plating may be achieved outside these ranges, however. In fact, the contact duration is at least partly a function of the desired thoroghness of the silver plating, the concentration of silver ions in the solution and the process used to apply the solution to the metal surface.

Additional optional steps may also be added. For example the metal surface may be cleaned prior to exposure to the silver deposit solution. This cleaning could be done using a weakly alkaline or acidic cleaning solution. Other possible cleaning solutions include highly built alkaline cleaners, solvents, acids and bases.

The metal surface could also be etched prior to exposure to the silver deposit solution. For example, etching could be done using a sodium persulfate etching solution, a peroxide etching solution, oxone etches, ferric metal etches, or cupric chloride etches.

The metal surface could be rinsed after the optional cleaning or etching steps. The metal surface could also be rinsed after contacting with the silver deposit solution. Demineralized water could be used for the optional rinsing steps. Drying steps could be done after these rinsing steps.

Non-limiting examples of other optional steps include a pre-dip to help protect the bath and a post-dip to help with rinsing or help to avoid tarnish on the silver.

In one embodiment the metal surface is positioned in a vertical or nearly vertical position. A vertical or nearly vertical positioning allows silver deposit solution to run off from the metal surface. This prevents pooling of silver deposit solution which can cause galvanic attack.

When the metal surface is vertically or nearly vertically positioned the silver deposit solution can be applied using a spraying method. A non-foaming or low foaming silver deposit solution is particularly suited for a spraying application method.

Additional optional steps may also be added to the spraying application method. Those optional steps discussed above could be added to the spraying application method. Other optional steps that could be particularly useful with the spraying application method could also be added.

A person familiar with the technology will understand that the conditions described above can be varied and adjusted to achieve the desired plating of silver onto the metal surface.

### EXAMPLE 1

In one non-limiting embodiment, a silver deposit solution was made that contained 2.4 grams per liter silver nitrate, 0.6 grams per liter 2,6-dihydroxy benzoic acid and 2 grams per liter Pluronic L44.

A copper test strip was prepared by first cleaning the test strip in a cleaner that contained 5 grams per liter Pluronic L44, 2.5 percent sulfuric acid, and 5 percent propylene glycol for 2 minutes. The test strip was rinsed and then submerged into a sodium persulfate micro etch for 1 minute.

The test strip was rinsed and submerged into a bath containing the silver deposit solution for 1.5 minutes, rinsed and dried. A uniform silver metal deposit was plated onto the copper surfaces.

### EXAMPLE 2

In one non-limiting embodiment a silver deposit solution was made as described in Example 1. 2 percent nitric acid and 0.02 M N-(2-hydroxyethyl)ethylenediamine-N,N′,N′-triacetic acid were also added to the silver deposit solution.

A copper test strip was prepared by first cleaning the test strip in a cleaner that contained 5 grams per liter Pluronic L44, 2.5 percent sulfuric acid, and 5 percent propylene glycol for 2 minutes. The test strip was rinsed and then submerged into a sodium persulfate micro etch for 1 minute.

The test strip was rinsed and submerged into a bath containing the silver deposit solution bath for 1.5 minutes, rinsed and dried. A uniform silver metal deposit was plated onto the copper surfaces.

### EXAMPLE 3

In one non-limiting embodiment, a silver deposit solution was made that contained 2.4 grams per liter silver nitrate, 2 grams per liter Pluronic L44-, and 0.75 grams per liter 3,5-dinitro salicylic acid.

A copper test strip was prepared by first cleaning the test strip in a cleaner that contained 5 grams per liter Pluronic L44, 2.5 percent sulfuric acid, and 5 percent propylene glycol for 2 minutes. The test strip was rinsed and then submerged into a sodium persulfate micro etch for 1 minute.

The test strip was rinsed and submerged into a bath containing the silver deposit solution for 1.5 minutes, rinsed and dried. A uniform silver metal deposit was plated onto the copper surfaces.

### EXAMPLE 4

In one non-limiting embodiment a silver deposit solution was made as described in Example 3. 3 percent nitric acid and 0.02 M N-(2-hydroxyethyl)ethylenediamine-N,N′,N′-triacetic acid were also added to the silver deposit solution.

A copper test strip was prepared by first cleaning the test strip in a cleaner that contained 5 grams per liter Pluronic L44, 2.5 percent sulfuric acid, and 5 percent propylene glycol for 2 minutes. The test strip was rinsed and then submerged into a sodium persulfate micro etch for 1 minute.

The test strip was rinsed and submerged into a bath containing the silver deposit solution bath for 1.5 minutes, rinsed and dried. A uniform silver metal deposit was plated onto the copper surfaces.

### EXAMPLE 5

In one non-limiting embodiment, a silver deposit solution was made that contained 2.4 grams per liter silver nitrate, 2 grams per liter Pluronic L44-, and 0.75 grams per liter 3,5-dinitro salicylic acid.

A copper test strip was prepared by first cleaning the test strip in a cleaner that contained 5 grams per liter Pluronic L44, 2.5 percent sulfuric acid, and 5 percent propylene glycol for 2 minutes. The test strip was rinsed and then submerged into a sodium persulfate micro etch for 1 minute.

The test strip was rinsed and sprayed with the silver deposit solution for 1.5 minutes, rinsed and dried. A uniform silver metal deposit was plated onto the copper surfaces.

### EXAMPLE 6

In one non-limiting embodiment a silver deposit solution was made as described in Example 5. 3 percent nitric acid and 0.02 M N-(2-hydroxyethyl)ethylenediamine-N,N′,N′-triacetic acid were also added to the silver deposit solution.

A copper test strip was prepared by first cleaning the test strip in a cleaner that contained 5 grams per liter Pluronic L44, 2.5 percent sulfuric acid, and 5 percent propylene glycol for 2 minutes. The test strip was rinsed and then submerged into a sodium persulfate micro etch for 1 minute.

The test strip was rinsed and sprayed with the silver deposit solution bath for 1.5 minutes, rinsed and dried. A uniform silver metal deposit was plated onto the copper surfaces.

### EXAMPLE 7

In one non-limiting embodiment, a silver deposit solution is made that contains 2.4 grams per liter silver nitrate, 0.6 grams per liter 2,6-dihydroxy benzoic acid and 1 g/L grams per liter Rhodafac RS 610.

A copper test strip is cleaned, rinsed and microetched. The test strip is rinsed and submerged into a bath containing the silver deposit solution for 1.5 minutes, rinsed and dried. A uniform silver metal deposit is plated onto the copper surfaces. The surface exhibits good dewetting.

### EXAMPLE 8

In one non-limiting embodiment a silver deposit solution is made as described in Example 7. 2 percent nitric acid and 0.02 M N-(2-hydroxyethyl)ethylenediamine-N,N′,N′-triacetic acid are also added to the silver deposit solution.

A copper test strip is cleaned, rinsed and microetched. The test strip is rinsed and submerged into a bath containing the silver deposit solution for 1.5 minutes, rinsed and dried. A uniform silver metal deposit is plated onto the copper surfaces. The surface exhibits good dewetting.

### EXAMPLE 9

In one non-limiting embodiment, a silver deposit solution is made that contains 2.4 grams per liter silver nitrate, 1 g/L grams per liter Rhodafac RS 610, and 0.75 grams per liter 3,5-dinitro salicylic acid.

A copper test strip is cleaned, rinsed and microetched. The test strip is rinsed and submerged into a bath containing the silver deposit solution for 1.5 minutes, rinsed and dried. A uniform silver metal deposit is plated onto the copper surfaces. The surface exhibits good dewetting.

### EXAMPLE 10

In one non-limiting embodiment a silver deposit solution is made as described in Example 9. 3 percent nitric acid and 0.02 M N-(2-hydroxyethyl)ethylenediamine-N,N′,N′-triacetic acid are also added to the silver deposit solution.

A copper test strip is cleaned, rinsed and microetched. The test strip is rinsed and submerged into a bath containing the silver deposit solution for 1.5 minutes, rinsed and dried. A uniform silver metal deposit is plated onto the copper surfaces. The surface exhibits good dewetting.

### EXAMPLE 11

In one non-limiting embodiment, a silver deposit solution is made that contains 2.4 grams per liter silver nitrate, 1 g/L grams per liter Rhodafac RS 610, and 0.75 grams per liter 3,5-dinitro salicylic acid.

A copper test strip is cleaned, rinsed and microetched. The test strip is rinsed and sprayed with the silver deposit solution for 1.5 minutes, rinsed and dried. A uniform silver metal deposit is plated onto the copper surfaces. The surface exhibits good dewetting.

### EXAMPLE 12

In one non-limiting embodiment a silver deposit solution is made as described in Example 9. 3 percent nitric acid and 0.02 M N-(2-hydroxyethyl)ethylenediamine-N,N′,N′-triacetic acid are also added to the silver deposit solution.

A copper test strip is cleaned, rinsed and microetched. The test strip is rinsed and sprayed with the silver deposit solution for 1.5 minutes, rinsed and dried. A uniform silver metal deposit is plated onto the copper surfaces. The surface exhibits good dewetting.

While particular elements, embodiments and applications have been shown and described, it will be understood, of course, that the invention is not limited thereto since modification can be made by those of skill in the art without departing from the scope of the present disclosure, particularly in light of the foregoing teachings.

What is claimed is:

1. A silver deposit solution comprising:
an acid selected from the group consisting of salicylic acid and salicylic acid derivatives;
a source of silver ions; and
an additive selected from the group consisting of polyethylene glycol, a block copolymer of polyethylene glycol and polypropylene glycol, polypropylene glycol, block copolymers based on ethylenediamine as a core derivatives of any of the foregoing and mixtures of any of the foregoing.

2. The silver deposit solution of claim 1 further comprising a mineral acid.

3. The silver deposit solution of claim 2 wherein said mineral acid is nitric acid.

4. The silver deposit solution of claim 3 further comprising a chelator.

5. The silver deposit solution of claim 4 wherein the chelator is selected from the group consisting of N-(2-hydroxyethyl)ethylenediaminetriacetic acid and its salts.

6. The silver deposit solution of claim 1 wherein said acid is 3,5-dinitro salicylic acid.

7. The silver deposit solution of claim 1 wherein said additive is a block copolymer of polyethylene glycol and polypropylene glycol.

8. The silver deposit solution of claim 1 wherein the source of silver ions is a silver salt.

9. The silver deposit solution of claim 1 wherein the silver deposit solution is non-foaming.

10. The silver deposit solution of claim 1 wherein the silver deposit solution is low foaming.

11. The silver deposit solution of claim 1 further comprising a surfactant.

12. The silver deposit solution of claim 11 wherein said surfactant is a phosphate ester surfactant.

13. The silver deposit solution of claim 11 wherein said surfactant is a phosphate ester of tridecyl alcohol ethoxylate.

14. A process of depositing silver onto a metal surface, comprising:
providing a metal surface; and
applying a silver deposit solution to the metal surface, the silver deposit solution comprising;
an acid selected from the group consisting of salicylic acid and salicylic acid derivatives;
a source of silver ions; and
an additive selected from the group consisting of polyethylene glycol, a block copolymer of polyethylene glycol and polypropylene glycol, polypropylene glycol, block copolymers based on ethylenediamine as a core, derivatives of any of the foregoing and mixtures of any of the foregoing.

15. The process of depositing silver onto a metal surface of claim 14 wherein the metal surface is copper.

16. The process of depositing silver onto a metal surface of claim 14 wherein the metal surface is on a printed wiring board.

17. The process of depositing silver onto a metal surface of claim 14 wherein the metal surface is positioned vertically.

18. The process of depositing silver onto a metal surface of claim 14 wherein the silver deposit solution is sprayed on the metal surface.

19. The process of depositing silver onto a metal surface of claim 14 wherein the silver deposit solution is non-foaming.

20. The process of depositing silver onto a metal surface of claim 14 wherein the silver deposit solution is low foaming

21. A silver deposit solution comprising:
an acid selected from the group consisting of salicylic acid and salicylic acid derivatives;
a source of silver ions; and
a phosphate ester surfactant.

22. The silver deposit solution of claim 21 further comprising a mineral acid.

23. The silver deposit solution of claim 22 wherein said mineral acid is nitric acid.

24. The silver deposit solution of claim 23 further comprising a chelator.

25. The silver deposit solution of claim 24 wherein the chelator is selected from the group consisting of N-(2-hydroxyethyl)ethylenediaminetriacetic acid and its salts.

26. The silver deposit solution of claim 21 wherein said acid is 3,5-dinitro salicylic acid.

27. The silver deposit solution of claim 21 wherein said phosphate ester surfactant is a phosphate ester of tridecyl alcohol ethoxylate.

28. The silver deposit solution of claim 21 wherein the source of silver ions is a silver salt.

29. The silver deposit solution of claim 21 wherein the silver deposit solution is non-foaming.

30. The silver deposit solution of claim 21 wherein the silver deposit solution is low foaming.

31. A process of depositing silver onto a metal surface, comprising:
providing a metal surface; and
applying a silver deposit solution to the metal surface, the silver deposit solution comprising;
an acid selected from the group consisting of salicylic acid and salicylic acid derivatives;
a source of silver ions; and
a phosphate ester surfactant.

32. The process of depositing silver onto a metal surface of claim 31 wherein the metal surface is copper.

33. The process of depositing silver onto a metal surface of claim 31 wherein the metal surface is on a printed wiring board.

34. The process of depositing silver onto a metal surface of claim 31 wherein the metal surface is positioned vertically.

35. The process of depositing silver onto a metal surface of claim 31 wherein the silver deposit solution is sprayed on the metal surface.

36. The process of depositing silver onto a metal surface of claim 31 wherein the silver deposit solution is non-foaming.

37. The process of depositing silver onto a metal surface of claim 31 wherein the silver deposit solution is low foaming

38. An aqueous silver deposit solution comprising
an acid;
a source of silver ions; and
an additional component
wherein said aqueous silver deposit solution forms less than 20 mL of foam when added to water in a graduated cylinder and agitated.
